(19) United States
(12) Patent Application Publication
(10) Pub. No.: US 2013/0076796 A1
(43) Pub. Date: Mar. 28, 2013

(54) MOBILE TERMINAL DEVICE

(71) Applicant: Takuya HAYASHI, Osaka (JP)

(72) Inventor: Takuya HAYASHI, Osaka (JP)

(73) Assignee: KYOCERA CORPORATION, Kyoto (JP)

(21) Appl. No.: 13/614,396

(22) Filed: Sep. 13, 2012

(30) Foreign Application Priority Data
Sep. 28, 2011 (JP) 2011-212436

(51) Int. Cl. G09G 5/00; G06F 3/041

(52) U.S. Cl. 345/661; 345/173

(57) ABSTRACT

A mobile electronic device and method are presented. One or more contacted positions are detected in response to a user contacting at least one contact detection module not located on a display module. An application program is executed in response to the contacted positions being transitioned, if the contacted positions comprise a predetermined number of contacts.

### CROSS-REFERENCE TO RELATED APPLICATION

The present application claims priority under 35 U.S.C. §119 to Japanese Patent Application No. 2011-212436, filed on Sep. 28, 2011, entitled “MOBILE ELECTRONIC DEVICE”. The content of which is incorporated by reference herein in its entirety.

### FIELD

Embodiments of the present disclosure relate generally to mobile electronic devices, and more particularly relate to mobile electronic devices comprising at least one touch sensor.

### BACKGROUND

It is desirable for portable electronic devices such as mobile phones and Personal Digital Assistances (PDAs) to be both small to be portable and large to be more useable. Chassis of portable electronic devices have been downsized so users can somewhat constantly carry around the portable electronic devices. The portable electronic devices also need to have large display screens such as liquid crystal displays to display, for example, texts of electronic mails, photographic imagery, web screens, etc.

In addition, in recent years it has been possible for portable electronic devices to realize complicated features comparing favorably with personal computers, and the like. When a user select an icon displayed on a display, it is possible for a user to select the icon by directly pressing down on the displayed icon. However, as a number of application programs stored in a portable electronic device increases, it is likely that the user will have considerable inconvenience searching for an application intended to be executed.

### SUMMARY

A mobile electronic device and method are presented. One or more contacted positions are detected in response to a user contacting at least one contact detection module not located on a display module. An application program is executed in response to the contacted positions being transitioned, if the contacted positions comprise a predetermined number of contacts.

In an embodiment, a mobile electronic device comprises a display module, a memory module, contact detection modules, and a controller. The memory module stores application programs. The contact detection modules are provided in a first region different from a second region in which the display module is located, and detect at least one contacted position in response to a user contacting at least one of the contact detection modules. The controller executes an application program from among the application programs in response to the at least one contacted position being transitioned, if the at least one contacted position comprises a predetermined number of contacts.

In another embodiment, a mobile electronic device comprises a display module, a memory module, contact detection modules, a first determination module, and a second determination module. The memory module stores application programs. The contact detection modules are provided in a first region different from a second region in which the display module is located, and detect a contact in response to a user contacting a position on the contact detection modules to provide a first contacted position. The first determination module determines if the first contacted position comprises a predetermined number of contacts. The second determination module determines if a combination of contact detection modules having detected the first contacted position comprises a specific combination, when the first determination module has determined that the first contacted position comprises the predetermined number of contacts.

In a further embodiment, a method for operating a mobile electronic device detects one or more contacted positions in response to a user contacting at least one of a plurality of contact detection modules not located on a display module. The method further executes an application program in response to the at least one contacted position being transitioned, if the contacted positions comprise a predetermined number of contacts.

In a further embodiment, a non-transitory computer readable storage medium comprises computer-executable instructions for operating a mobile electronic device. The computer-executable instructions detect one or more contacted positions in response to a user contacting at least one of a plurality of contact detection modules not located on a display module. The computer-executable instructions further execute an application program in response to the at least one contacted position being transitioned, if the contacted positions comprise a predetermined number of contacts.

### BRIEF DESCRIPTION OF THE DRAWINGS

Embodiments of the present disclosure are hereinafter described in conjunction with the following figures, wherein like numerals denote like elements. The figures are provided for illustration and depict exemplary embodiments of the present disclosure. The figures are provided to facilitate understanding of the present disclosure without limiting the breadth, scope, scale, or applicability of the present disclosure.

FIG. 1 is an illustration of a perspective view of a mobile phone according to an embodiment of the disclosure.

FIG. 2 is an illustration of a functional block diagram of a mobile phone according to an embodiment of the disclosure.

FIG. 3 is an illustration of a diagram showing a mobile phone device viewed from a side surface according to an embodiment of the disclosure.

FIG. 4 is an illustration of a display module showing a user contacting touch sensors at contact positions on a standby screen according to an embodiment of the disclosure.

FIG. 5 is an illustration of a display module showing a user contacting additional touch sensors (in addition to the touch sensors of FIG. 4) at additional contact positions according to an embodiment of the disclosure.

FIG. 6 is an illustration of a display module showing the additional contact positions shown in FIG. 5 have transitioned according to an embodiment of the disclosure.

FIG. 7 is an illustration of a screen displayed on a display module after a slide operation has been detected according to an embodiment of the disclosure.

FIG. 8 is an illustration of a flowchart showing a display process performed by a mobile phone according to an embodiment of the disclosure.

FIG. 9 is an illustration of a display module showing a user has contacted a touch sensor according to an embodiment of the disclosure.

FIG. 10 is an illustration of a display module showing a screen displayed on the display module after a slide operation has been detected according to an embodiment of the disclosure.

### DETAILED DESCRIPTION

The following description is presented to enable a person of ordinary skill in the art to make and use the embodiments of the disclosure. The following detailed description is exemplary in nature and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the disclosure. The present disclosure should be accorded scope consistent with the claims, and not limited to the examples described and shown herein.

Embodiments of the disclosure are described herein in the context of one practical non-limiting application, namely, a mobile electronic device such as a mobile phone. Embodiments of the disclosure, however, are not limited to such mobile phone, and the techniques described herein may be utilized in other applications. For example, embodiments may be applicable to digital books, digital cameras, electronic game machines, digital music players, personal digital assistance (PDA), personal handy phone system (PHS), lap top computers, TV's, display monitors, or other electronic device that uses touch sensors.

As would be apparent to one of ordinary skill in the art after reading this description, these are merely examples and the embodiments of the disclosure are not limited to operating in accordance with these examples. Other embodiments may be utilized and structural changes may be made without departing from the scope of the exemplary embodiments of the present disclosure.

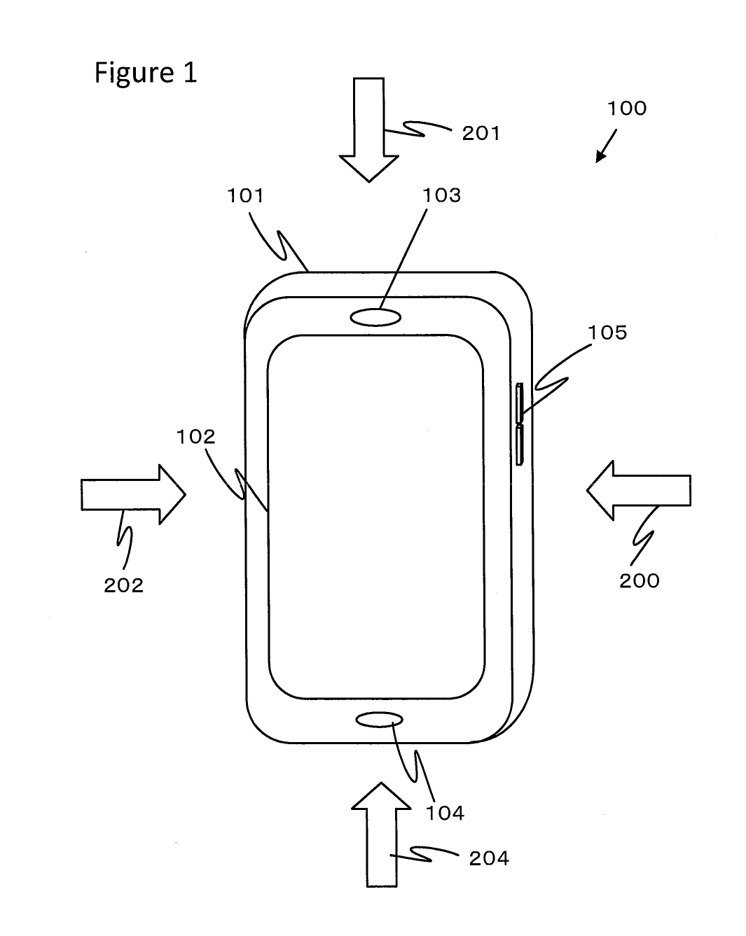

FIG. 1 is an illustration of a perspective view of a mobile phone 100 according to an embodiment of the disclosure. A chassis comprises a touch panel 102, a speaker 103, a microphone 104, and an operation module 105. The touch panel 102 displays a key group including a cursor key, a numerical keypad, an icon, and other image for activating a function.

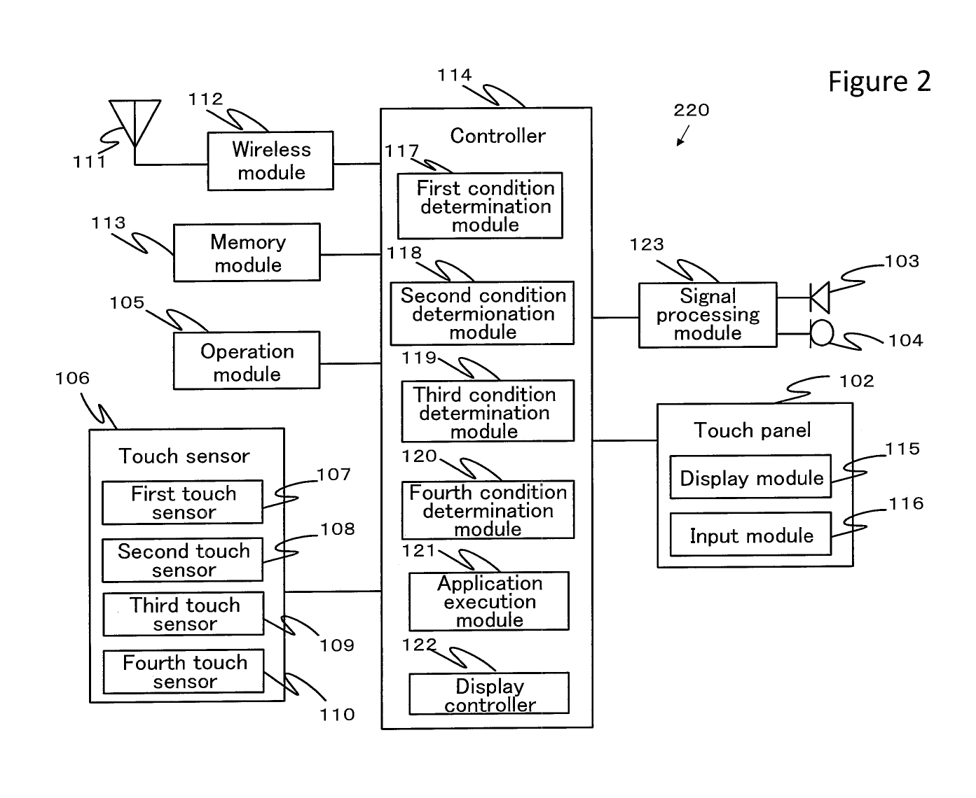

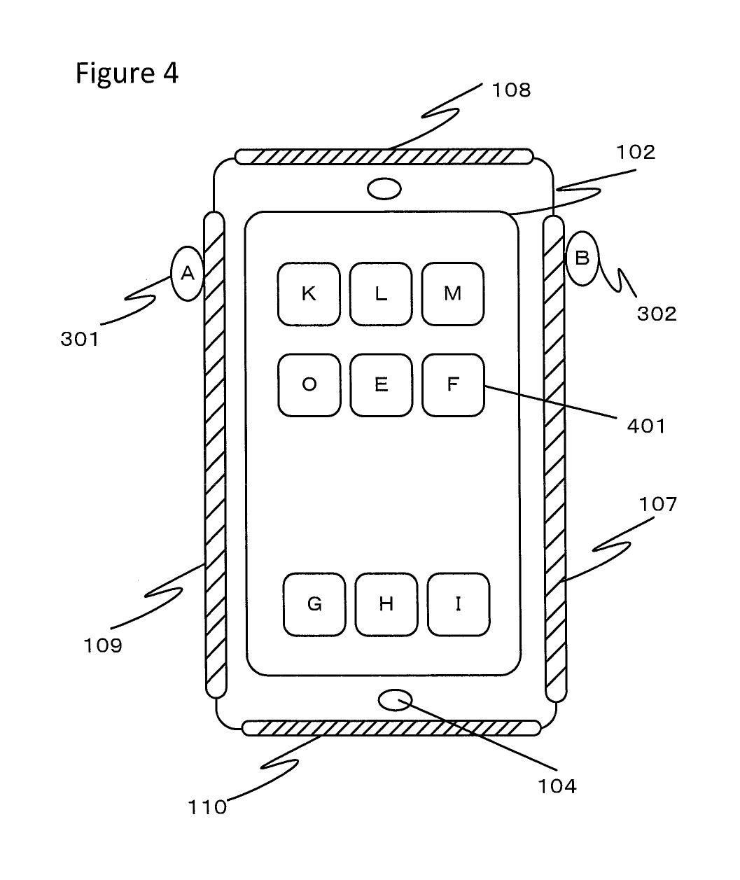

In addition, a first touch sensor 107, a second touch sensor 108, a third touch sensor 109, and a fourth touch sensor 110 are provided on side surfaces of the mobile phone 100 as shown in FIG. 4. The first to fourth touch sensors 107/108/109/110 may be collectively referred to as a touch sensor 106, in some cases in this document. In addition, the first touch sensor 107 is provided on a side surface when the mobile phone 100 is viewed from the direction of an arrow 200 (also see FIGS. 2 and 4). The second touch sensor 108 is provided on a side surface when the mobile phone 100 is viewed from a direction of an arrow 201. The third touch sensor 109 is provided on a side surface when the mobile phone 100 is viewed from the direction of an arrow 202. The fourth touch sensor 110 is provided on a side surface when the mobile phone 100 is viewed from a direction of an arrow 203.

FIG. 2 is an illustration of a functional block diagram 220 (system 220) of the mobile phone 100 according to an embodiment of the disclosure. The mobile phone 100 comprises a wireless module 112, a microphone 104, a speaker 103, a signal processing module 123, an operation module 105, a touch panel 102, a touch sensor 106, a memory module 113, and a controller 114.

The wireless module 112 performs modulation and demodulation of signals transmitted and received through an antenna 111. In addition, the wireless module 112 is configured to receive a telephone call request transmitted from another mobile phone, through the antenna 111. The wireless module 112 is also configured to transmit a telephone call request to another mobile phone. The wireless module 112 outputs the received telephone call request to the controller 114. In addition, the wireless module 112 may receive data such as an electronic mail (E-mail) transmitted from another mobile phone, and output the data to the controller 114.

The signal processing module 123 performs processing for transmitting a sound signal that is input from the microphone 104, through the wireless module 112 and processing for outputting a sound signal that is received from the antenna 111 through the wireless module 112, to the speaker 103.

The microphone 104 outputs, as a sound signal, an input sound to the signal processing module 123.

The speaker 103 outputs, as a sound, a sound signal processed in the signal processing module 123 or sound data received from the controller 114.

The operation module 105 is configured to accept an operation from a user. The operation module 105 outputs the accepted operation to the controller 114. The operation module 105 comprises a hard key, and other functional key.

The touch panel 102 comprises a display module 115 and an input module 116.

The display module 115 is configured to display images, such as but without limitation, a character, an icon, and other image according to an instruction from the controller 114. The input module 116 detects a touch from a user, and outputs a coordinate value of a touched position to the controller 114 and the memory module 113 at every unit time (e.g., 1/60 seconds) during a detection of the touch. The display module 115 may comprise, for example but without limitation, a liquid crystal display (LCD), or other display technology.

The term “touch” means that a user touches the input module 116 using a finger, a stylus pen, or other display touching means. A term “detach” means that when the user touches the input module 116 using a finger or other display touching means, the user moves the touching finger or other display touching means away from the input module 116. A term “slide” means that when the user touches the input module 116 using a finger or other display touching means, the touching finger or other display touching means of the user moves while maintaining contact with the input module 116. When the input module 116 detects a coordinate value, the controller 114 determines that the display is touched. When the coordinate value is not detected after the coordinate value is detected, the controller 114 determines that the display is detached from a touch. When the detected coordinate value changes with time, the controller 114 determines the action as a slide.

The input module 116 may be realized by using, for example but without limitation, a resistive film method, an optical method, an electrostatic capacitance coupling method, or other method used for detecting input on a touch panel. In addition, the input module 116 may also simultaneously detect a plurality of touches from the user. When having detected one touch from the user, the input module 116 may also detect a new touch from the user. The input module 116 may output the coordinate value of an already touched position and the coordinate value of a newly touched position to the controller 114.

The touch sensor 106 is configured to detect a contact from the user. The touch sensor 106 comprises at least the first to fourth touch sensors 107 to 110. The first to fourth touch sensors 107 to 110 are provided on the surfaces of the side surfaces of the mobile phone 100 or within the mobile phone 100. The touch sensor 106 detects a touch from a user, and outputs the coordinate value of the touched position to the memory module 113 via the controller 114 every unit time (for example, 1/60 seconds) during the detection of the touch. The touch sensor 106 may be realized by using, for example but without limitation, a resistive film method, an optical method, an electrostatic capacitance coupling method, or other method used for sensing a touch on a touch panel.

The memory module 113 may be any suitable data storage area with suitable amount of memory that is formatted to support the operation of the mobile phone 100. Memory module 113 is configured to store, maintain, and provide data as needed to support the functionality of the mobile phone 100 in the manner described below. In some embodiments, the memory module 113 may comprise, for example but without limitation, a non-volatile storage device (non-volatile semiconductor memory, hard disk device, optical disk device, and the like), a random access storage device (for example, SRAM, DRAM), or any other form of storage medium known in the art.

For example the memory module 50, may comprise a RAM 34 and a flash memory. The RAM may be used as a work area (including a drawing area) or as a buffer area for the controller 114. A flash memory may store content data of the mobile phone 100, such as but without limitation, characters, letters, images, audios, sounds, movies, or other content data. The memory module 113 may be coupled to the controller 114 and configured to store, for example but without limitation, application programs, address book, phone numbers, or other data. The memory module 113 may also store information indicating whether or not the application programs are applications to be executed using a slide operation described below.

In addition, during the detection of a touch from the user, the memory module 113 may store a coordinate value output from the input module 116 or from the touch sensor 106 every unit time (for example, 1/60 seconds). Namely, the memory module 113 may store a coordinate value output between a touch state and a detaching state. The controller 114 comprises a first condition determination module 117, a second condition determination module 118, a third condition determination module 119, a fourth condition determination module 120, an application execution module 121, and a display controller 122, and controls the operation of the mobile phone 100.

The controller 114 is capable of controlling functions of the mobile phone 100. The controller 114 may be implemented or realized with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein.

In this manner, a controller may be realized as a microprocessor, a central processing unit (CPU), a microcontroller, a state machine, or other hardware and/or software device. A controller may also be implemented as a combination of computing devices, e.g., a combination of a digital signal processor and a microprocessor, a plurality of microprocessors, one or more microprocessors in conjunction with a digital signal processor core, or any other such configuration.

The first condition determination module 117 determines whether or not at least two contact positions detected in the touch sensor 106 exist. When having determined that more than one contact position exists, the first condition determination module 117 outputs that effect to the second condition determination module 118.

The second condition determination module 118 identifies which touch sensor has detected the two contact positions, and determines whether or not a combination of the touch sensors having detected the two contact positions corresponds to a specific combination. For example, the specific combination corresponds to whether or not touch sensors facing each other have detected. The touch sensors facing each other correspond to the first touch sensor 107 and the third touch sensor 109 or the second touch sensor 108 and the fourth touch sensor 110.

For another example, in a case where the first condition determination module 117 has determined that the two contact positions have been detected, when the detected contact positions are respective contact positions detected by the first touch sensor 107 and the third touch sensor 109, the second condition determination module 118 determines that the two contact positions correspond to a specific combination.

For another example, in a case where the first condition determination module 117 has determined that the two contact positions have been detected, when the detected contact positions are respective contact positions detected by the second touch sensor 108 and the fourth touch sensor 110, the second condition determination module 118 determines that the two contact positions correspond to a specific combination.

For another example, in a case where the first condition determination module 117 has determined that the two contact positions have been detected, when the detected contact positions are respective contact positions detected by the second touch sensor 108 and the third touch sensor 109, the second condition determination module 118 determines that the two contact positions do not correspond to a specific combination.

For another example, in a case where the first condition determination module 117 has determined that the two contact positions have been detected, when the detected contact positions are respective contact positions detected by the second touch sensor 108 and the first touch sensor 107, the second condition determination module 118 determines that the two contact positions do not correspond to a specific combination.

When the second condition determination module 118 has determined that two contact positions correspond to a specific combination, the third condition determination module 119 determines whether or not two contact positions other than the determined contact positions exist. When having determined that two contact positions exist, the third condition determination module 119 outputs the result to the fourth condition determination module 120.

The fourth condition determination module 120 determines whether or not the two contact positions detected by the third condition determination module 119 satisfy a specific condition. The specific condition corresponds to whether or not the two contact positions have transitioned every unit time. Namely, the fourth condition determination module 120 determines whether or not the two contact positions have moved. When having determined that the two contact positions have transitioned, the fourth condition determination module 120 outputs the result to the application execution module 121.

In one embodiment, an operation satisfying the first condition determination module 117 to the fourth condition determination module 120 is referred to as a “slide operation”.

The application execution module 121 is capable of executing an application program stored in the memory module 113. When the slide operation has been detected, the application execution module 121 executes a pre-defined application program. In one embodiment, the predefined application program will be described using an application relating to E-mail creation. In addition, the preliminarily defined application program may also be an application other than the application relating to mail creation.

The display controller 122 is capable of controlling a screen to be displayed in the display module 115. The display controller 122 causes the display module 115 to display a screen relating to an application program executed by the application execution module 121.

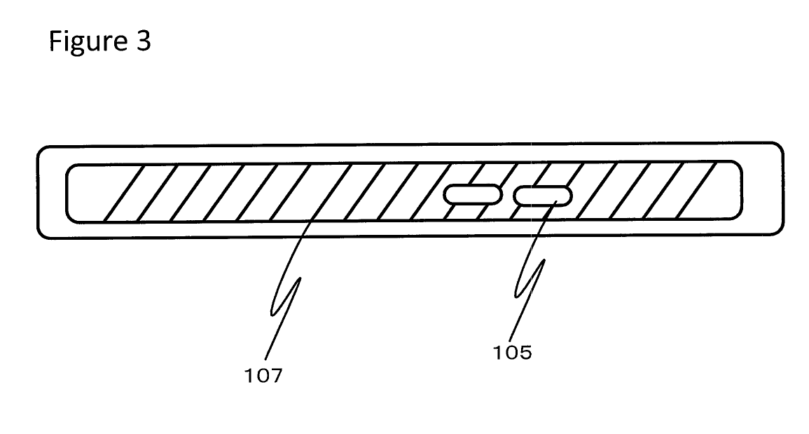

FIG. 3 is an illustration of a diagram showing the mobile phone 100 device viewed from a side surface viewed from the direction of the arrow 200 according to an embodiment of the disclosure. The first touch sensor 107 is provided in a region surrounded by diagonal lines. The same is also true for other touch sensors.

A slide operation is described below in conjunction with FIGS. 4-7. The following is an example where the slide operation has been detected and an application is executed.

FIG. 4 is an illustration of the display module 115 showing a user contacting touch sensors at contact positions on a standby screen (a contact position A301 and a contact position B302) according to an embodiment of the disclosure.

In addition, in one embodiment, a region indicated by a diagonal line indicates a touch sensor. Since two contacts have been detected, the first condition determination module 117 outputs the result to the second condition determination module 118. Since the contact position A301 has been detected by the third touch sensor 109 and the contact position B302 has been detected by the first touch sensor 107, the second condition determination module 118 outputs the result to the third condition determination module 119.

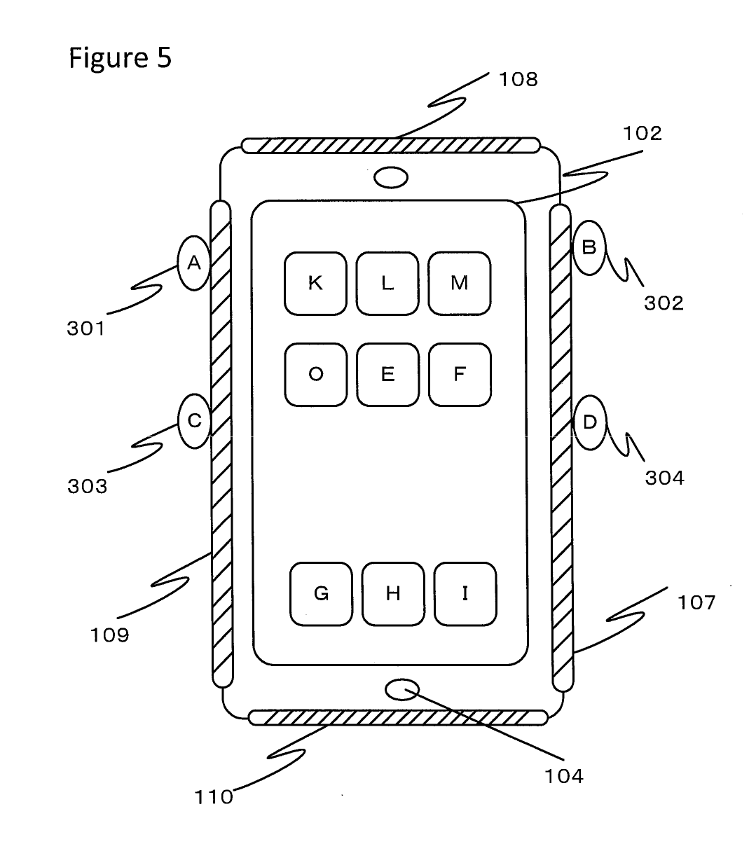

In FIG. 4, since the contact position A301 and the contact position B302 have been only detected, the third condition determination module 119 determines that it does not correspond to a condition. In addition, in FIG. 4, a plurality of icons 401 are displayed in the touch panel 102. The icon 401 indicates an application program, and it is possible for the user to execute an application program corresponding to the icon 401, by touching the icon 401. The same is also true for FIGS. 5, 6, and 9.

FIG. 5 is an illustration of the display module 115 showing a user contacting additional touch sensor 106 (a contact position C303 and a contact position D304) at additional contact positions according to an embodiment of the disclosure. Since the new contact position C303 and contact position D304 have been detected in addition to the contact position A301 and the contact position B302, the third condition determination module 119 determines that it corresponds to a condition, and outputs the result to the fourth condition determination module 120. Since the contact position C303 and the contact position D304 have not transitioned, the fourth condition determination module 120 determines that it does not correspond to a condition.

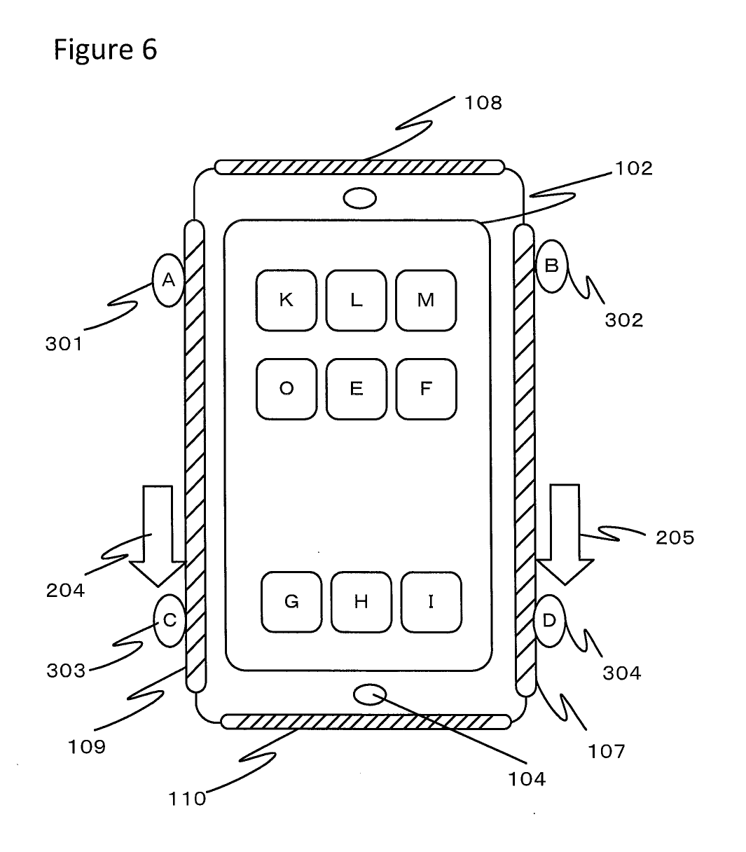

FIG. 6 is an illustration of the display module 115 showing the additional contact positions (contact position C303 and the contact position D304) shown in FIG. 5 have transitioned according to an embodiment of the disclosure. The contact position C303 has transitioned in the direction of an arrow 204 and the contact position D304 has transitioned in the direction of an arrow 205. Since the contact position C303 and the contact position D304 have transitioned, the fourth condition determination module 120 determines that it corresponds to a condition, and outputs the result to the application execution module 121. In addition, FIG. 4 to FIG. 6 corresponds to a process where it is determined as the slide operation.

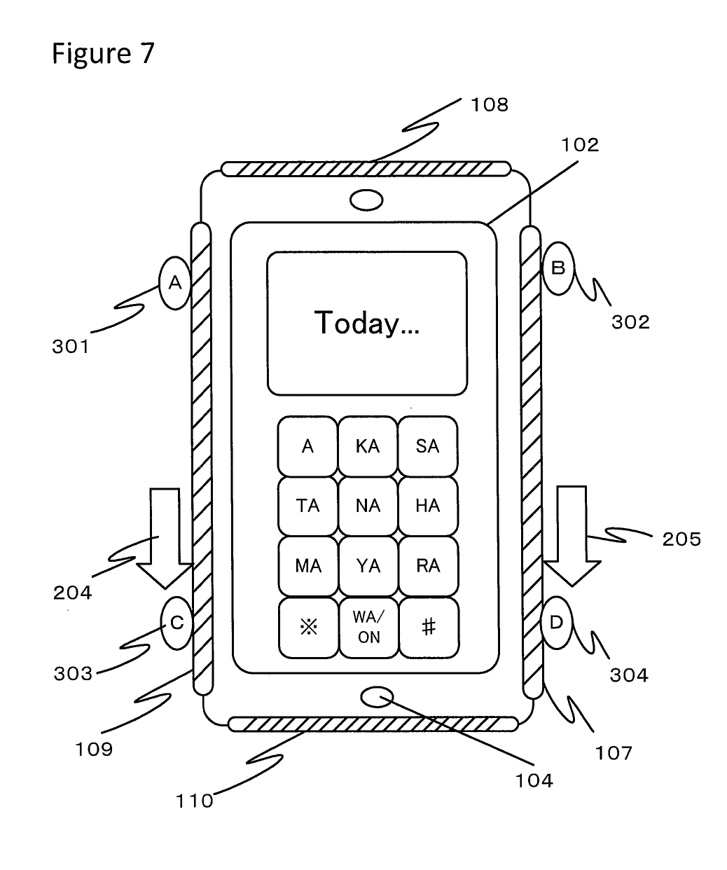

FIG. 7 is an illustration of a screen displayed on a display module 115 after the slide operation has been detected according to an embodiment of the disclosure. When the slide operation has been detected, the application execution module 121 executes an application program associated with the slide operation. The display controller 122 causes the display module 115 to display a screen relating to the executed application. FIG. 7 is a screen where a mail creation screen has been executed, as an example of an application program associated with the slide operation. In FIG. 7, a region where characters or numbers to be input are displayed and a region where input characters are displayed are displayed. In addition, in FIG. 7, each row of the Japanese language is assigned to one key. For example, the “A” row is assigned to “A”.

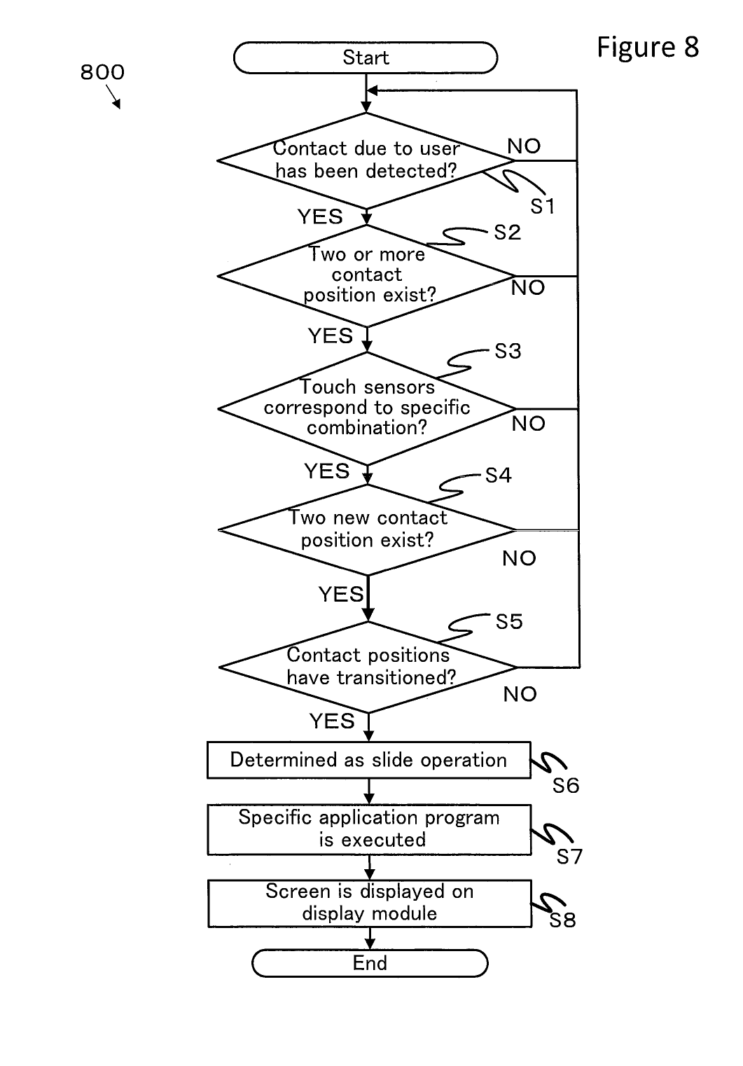

FIG. 8 is an illustration of a flowchart showing a display process 800 (process 800) performed by the mobile phone 100 according to an embodiment of the disclosure. The various tasks performed in connection with the process 800 may be performed by software, hardware, firmware, a computer-readable medium having computer executable instructions for performing the process method, or any combination thereof. The process 800 may be recorded in a computer-readable medium such as a semiconductor memory, a magnetic disk, an optical disk, and the like, and can be accessed and executed, for example, by a computer CPU such as the controller 114 in which the computer-readable medium is stored.

It should be appreciated that process 800 may include any number of additional or alternative tasks, the tasks shown in FIG. 8 need not be performed in the illustrated order, and process 800 may be incorporated into a more comprehensive procedure or process having additional functionality not described in detail herein. In some embodiments, portions of the process 800 may be performed by different elements of the system 220 such as: the wireless module 112, the microphone 104, the speaker 103, the signal processing module 123, the operation module 105, the touch panel 102, the touch sensor 106, the memory module 113, the controller 114, etc. Process 800 may have functions, material, and structures that are similar to the embodiments shown in FIGS. 1-2. Therefore common features, functions, and elements may not be redundantly described here.

When the touch sensor 106 has detected a contact from a user, the touch sensor 106 outputs information relating to a contact position, to the first condition determination module 117 (task S1). The first condition determination module 117 determines whether or not at least two or more contact positions detected by the touch sensor 106 exist (task S2). When the first condition determination module 117 has determined that more than one contact position detected by the touch sensor 106 exists (task S2: YES), the first condition determination module 117 outputs that the result to the second condition determination module 118.

Next, the second condition determination module 118 determines whether or not the combination of the touch sensor 106 where the contact of the user, which has become the target of determination in response to an action of the first condition determination module 117, has been detected corresponds to a specific combination (task S3). When the combination has been determined to correspond to a specific combination, the second condition determination module 118 outputs the result to the third condition determination module 119 (task S3: YES).

Next, the third condition determination module 119 determines whether or not two contact positions other than the determined contact positions exist (task S4). When having determined that two contact positions other than the determined contact positions exist, the third condition determination module 119 outputs the result to the fourth condition determination module 120 (task S4: YES).

Next, the fourth condition determination module 120 determines whether or not the two contact positions determined by the third condition determination module 119 have transitioned every unit time (task S5). When having determined that the two contact positions have transitioned every unit time, the fourth condition determination module 120 outputs the result to the application execution module 121 (task S5: YES).

Next, when the result has been output from the fourth condition determination module 120, the application execution module 121 determines that the slide operation has been executed (task S6). The application execution module 121 executes an application program associated with the slide operation (task S7). The display controller 122 causes the display module 115 to display a screen relating to the executed application program (task S8).

As a result of such an operation as described above, it is possible for the user to execute a specific application using the touch sensor 106.

While, in one embodiment, an application to be executed when the slide operation has been detected has been described with using an application program relating to an E-mail creation, the application to be executed when the slide operation has been detected may also be an application relating to the reception of television broadcasting or an application relating to taking images with a camera. In addition, when the slide operation has been detected, the mobile phone 100 may also display a phone number used for making a call to another mobile phone 100.

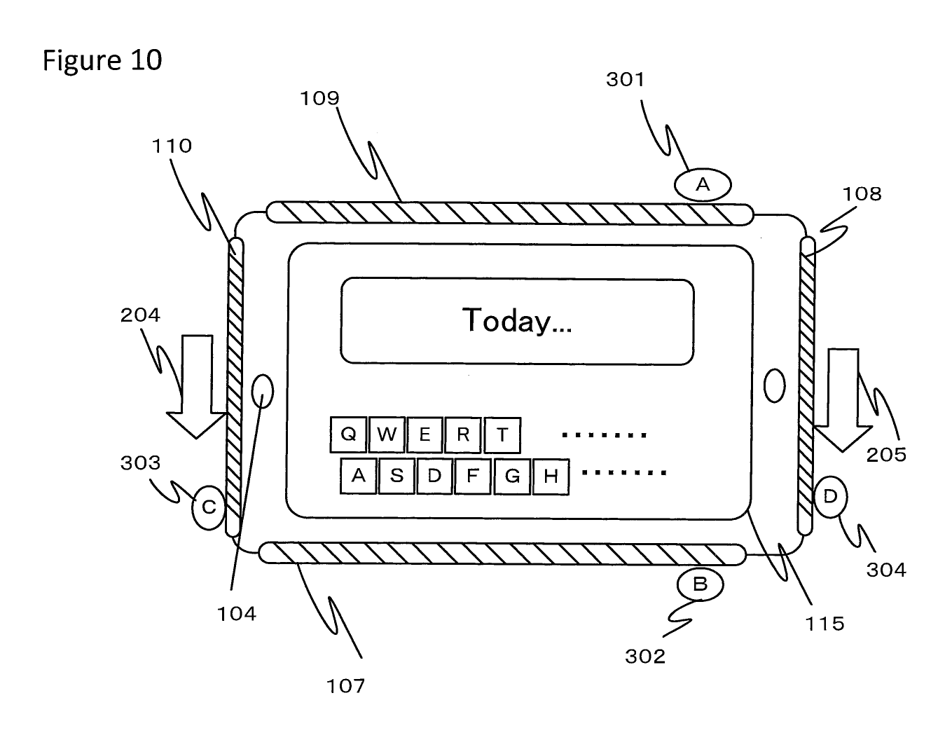

In addition, the slide operation may resemble an operation causing a slide type mobile phone to transition from a closed state to an open state. Therefore, in the same way as a hard key accepting a character input becomes exposed when the slide type mobile phone has been put into an open state, when the slide operation has been detected, the display controller 122 may also cause the display module 115 to display, for example, a key input screen illustrated in FIG. 7, FIG. 10, or the like.

Accordingly, even if a mobile phone such as the mobile phone illustrated in FIG. 1 is different from such a slide type mobile phone, it is possible for the user to cause the mobile phone to display a key input screen in the same way as the user would use the slide type mobile phone. Accordingly, it is possible for the user to reduce an inconvenience of searching for, for example, an icon for displaying a key input screen, and it is possible for the user to intuitively cause the display module 115 to display a key input module.

Furthermore, the second condition determination module 118 may also determine whether or not the combination of touch sensors that have detected two contact positions determined by the third condition determination module 119 corresponds to a specific combination. When the second condition determination module 118 determines that the combination of touch sensors that have detected two contact positions that are determined by the third condition determination module 119 corresponds to a specific combination, the fourth condition determination module 120 may also determine whether or not the two contact positions have transitioned every unit time.

The display controller 122 may also control the display of a screen on the basis of the transition of contact positions that are detected in the fourth condition determination module 120. For example, in response to the transitions of the contact position C303 and the contact position D304 in the directions of the arrows 204 and 205 in FIG. 6, the display controller 122 may also display a screen in such a way as illustrated in FIG. 7.

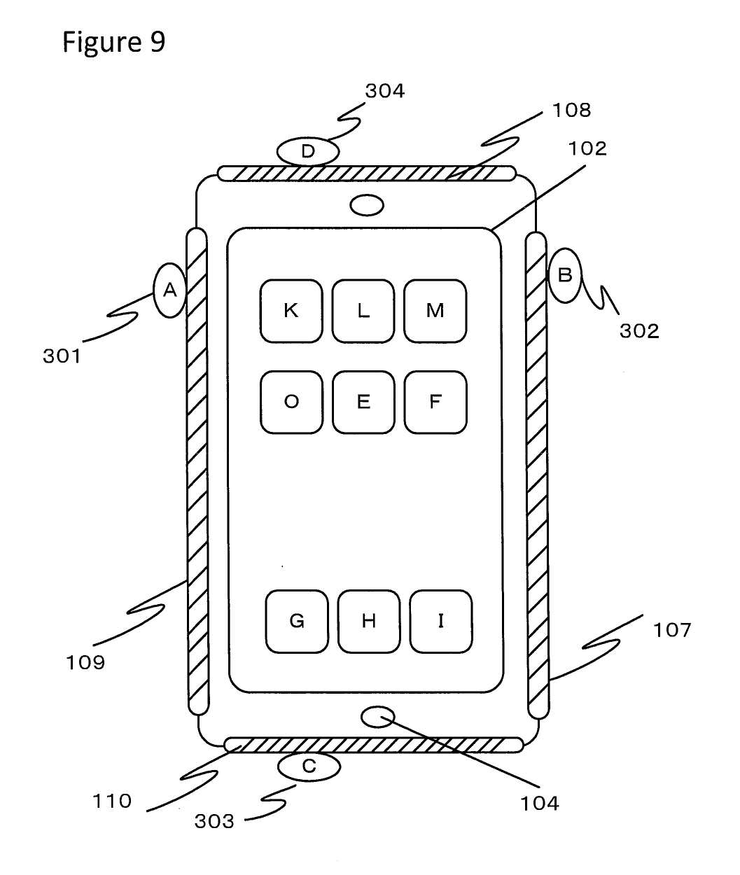

In addition, when the contact position C303 has been detected in the second touch sensor 108 and the contact position D304 has been detected in the fourth touch sensor 110 as illustrated in FIG. 9, the display controller 122 may also cause the display module 115 to display a screen in such a way as illustrated in FIG. 10. Since a transition direction is different between FIG. 7 and FIG. 10, the directions of displayed screens are different from each other. Operation keys displayed in FIG. 10 are described in a QWERTY format as an example.

According to the transitions of the contact position C303 and the contact position D304, the display controller 122 may also cause a screen to be displayed that relates to an application to be executed. Namely, the display controller 122 causes a screen to be displayed in accordance with the amounts of transition of the contact position C303 and the contact position D304. As the amount of transition increases, the size of a screen to be displayed changes.

While, in one embodiment, it has been described that when one of determinations performed in the first condition determination module 117 to the fourth condition determination module 120 is not satisfied, the processing returns to S1, an embodiment is not necessarily limited to this case. In response to a condition due to which condition determination module of the first condition determination module 117 to the fourth condition determination module 120 has not been satisfied, an application to be executed may also be defined.

For example, when a condition due to the third condition determination module 119 is not satisfied in a case where a condition due to the second condition determination module 118 is satisfied, a camera may be activated, for example. For example, when a condition due to the fourth condition determination module 120 is not satisfied in a case where a condition due to the third condition determination module 119 is satisfied, a music reproduction may be activated, for example. In addition, an application to be executed is not limited to this case, and may also be arbitrarily set by a user.

While one embodiment has been described so as to comprise the first to fourth touch sensors 107 to 110, an embodiment is not necessarily limited to this case. The side surface of the mobile phone 100 may also be covered by one touch sensor.

In this document, the terms “computer program product”, “computer-readable medium”, and the like may be used generally to refer to media such as, for example, memory, storage devices, or storage unit. These and other forms of computer-readable media may be involved in storing one or more instructions for use by the controller 114 to cause the controller 114 to perform specified operations. Such instructions, generally referred to as “computer program code” or “program code” (which may be grouped in the form of computer programs or other groupings), when executed, enable a method of using the system 220.

Terms and phrases used in this document, and variations hereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future.

Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the present disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The term “about” when referring to a numerical value or range is intended to encompass values resulting from experimental error that can occur when taking measurements.

1. A mobile electronic device comprising:
a display module;
a memory module operable to store a plurality of application programs;
a plurality of contact detection modules provided in a first region different from a second region in which the display module is located, and operable to detect at least one contacted position in response to a user contacting at least one of the contact detection modules; and
a controller operable to execute at least one application program from among the application programs in response to the at least one contacted position being transitioned, if the at least one contacted position comprises a predetermined number of contacts.

2. The mobile electronic device according to claim 1, wherein the controller is further operable to display an image on the display module in the direction in which the at least one contacted position has transitioned.

3. The mobile electronic device according to claim 2, wherein the controller is further operable to control a size of the image displayed on the display module, according to an amount of transition of the position contacted by the user.

4. The mobile electronic device according to claim 1, wherein the predetermined number is two.

5. The mobile electronic device according to claim 1, wherein the contact detection modules comprise at least four contact detection modules.

6. The mobile electronic device according to claim 1, further comprising a chassis operable to comprise at least six surfaces, wherein:
a first surface and a second surface are in a relationship where the first surface and the second surface face each other, wherein the display module is provided on the first surface;
a third surface and a fourth surface are in a first relationship where the third surface and the fourth surface face each other; and
a fifth surface and a sixth surface is in a second relationship where the fifth surface and the sixth surface face each other, wherein the contact detection modules are provided on the third surface, the fourth surface, the fifth surface and the sixth surface.

7. The mobile electronic device according to claim 6, further comprising a second determination module operable to determine if a combination of contact detection modules having detected the at least one contacted position comprises a specific combination, if the at least one contacted position comprises the predetermined number.

8. The mobile electronic device according to claim 7, wherein the specific combination comprises one of: a first set of the contact detection modules provided in the third surface and the fourth surface detect respective contacted positions, and a second set of the contact detection modules provided in the fifth surface and the sixth surface detect respective contacted positions.

9. A mobile electronic device comprising:
a display module;
a memory module operable to store a plurality of application programs;
a plurality of contact detection modules provided in a first region different from a second region in which the display module is located, and operable to detect a contact in response to a user contacting a position on the contact detection modules to provide a first contacted position;
a first determination module operable to determine if the first contacted position comprises a predetermined number of contacts; and
a second determination module operable to determine if a combination of contact detection modules having detected the first contacted position comprises a specific combination, when the first determination module has determined that the first contacted position comprises a predetermined number of contacts.

10. The mobile electronic device according to claim 9, further comprising a third determination module operable to determine if a second number of a second contacted position different from the first contacted position is equal to the predetermined number, if the second determination module has determined that the combination of the contact detection modules comprises the specific combination.

11. The mobile electronic device according to claim 10, further comprising:
a fourth determination module configured to determine whether or not the second contacted position has transitioned, if the third determination module has determined that the second number of the second contacted position satisfies the predetermined number; and
an execution module configured to execute at least one of the application programs when the fourth determination module has determined that the second contacted position has transitioned.

12. The mobile electronic device according to claim 11, further comprising:
a display controller operable to cause the display module to display an image relating to the at least one of the application programs executed by the execution module, wherein
the display controller causes a direction of an image displayed on the display module to be different, in accordance to a direction in which the second contacted position has transitioned.

13. The mobile electronic device according to claim 10, wherein the specific combination comprises one of: contact detection modules provided on a third surface and a fourth surface detect respective contacts, and contact detection modules provided on a fifth surface and a sixth surface detect respective contacts.

14. The mobile electronic device according to claim 9, wherein the predetermined number is two.

15. The mobile electronic device according to claim 9, wherein the detection modules comprise at least four or more contact detection modules.

16. A method for operating a mobile electronic device comprising:
detecting at least one contacted position in response to a user contacting at least one of a plurality of contact detection modules not located on a display module; and
executing at least one application program in response to the at least one contacted position being transitioned, if the at least one contacted position comprises a predetermined number of contacts.

17. The method of claim 16, further comprising changing a first direction of an image displayed on the display module in response to a second direction in which the at least one contacted position has transitioned.

18. The method of claim 17, further comprising controlling a size of the image displayed on the display module, according to an amount of transition of the at least one contacted position.

19. The method of claim 16, wherein the predetermined number is two.

20. The method of claim 16, wherein the contact detection modules comprise at least four contact detection modules.

21. A non-transitory computer readable storage medium comprising computer-executable instructions for operating a mobile electronic device, the computer-executable instructions comprising:
detecting at least one contacted position in response to a user contacting at least one of a plurality of contact detection modules not located on a display module; and
executing at least one application program in response to the at least one contacted position being transitioned, if the at least one contacted position comprises a predetermined number of contacts.
